(19) United States
(12) Patent Application Publication
(10) Pub. No.: US 2019/0196117 A1
(43) Pub. Date: Jun. 27, 2019

(54) OPTICAL CONNECTOR FERRULE AND OPTICAL CONNECTOR

(71) Applicants: SUMITOMO ELECTRIC INDUSTRIES, LTD., Osaka-shi, Osaka (JP); SEI Optifrontier Co., Ltd., Yokohama-shi, Kanagawa (JP)

(72) Inventors: Masaki OHMURA, Yokohama-shi, Kanagawa (JP); Masashi OKA, Yokohama-shi, Kanagawa (JP); Tsutomu KAMADA, Yokohama-shi, Kanagawa (JP)

(73) Assignees: SUMITOMO ELECTRIC INDUSTRIES, LTD., Osaka-shi, Osaka (JP); SEI Optifrontier Co., Ltd., Yokohama-shi, Kanagawa (JP)

(21) Appl. No.: 16/323,804

(22) PCT Filed: Aug. 4, 2017
(86) PCT No.: PCT/JP2017/028418

§ 371 Date: Feb. 7, 2019

(30) Foreign Application Priority Data
Sep. 23, 2016 (JP) 2016-185400

(51) Int. Cl. G02B 6/38; G02B 6/40

(52) U.S. Cl. CPC G02B 6/3861; G02B 6/3885; G02B 6/3865; G02B 6/40

(57) ABSTRACT

An optical connector ferrule comprising a first end, a second end, and an outer surface extending between the first and second ends is disclosed. The optical connector ferrule comprises an opening; an introducing hole which extends from the opening to the first end; optical fiber holes which pass through from a tip portion of the introducing hole to the first end; and a window which opens to the outer surface and is connected to the introducing hole, and into which an adhesive is injected. A first opening of the window closer to the outer surface is larger than a second opening of the window closer to the introducing hole. An inner wall of the window includes a first surface provided in the peripheral direction of the inner wall, and the first surface is positioned closer to the introducing hole with respect to the outer surface, and faces the outer surface.

### TECHNICAL FIELD

The present invention relates to an optical connector ferrule and an optical connector. This application claims the benefit of priority of Japanese Patent Application No. 2016-185400, filed on Sep. 23, 2016, the content of which is incorporated herein by reference in its entirety.

### BACKGROUND ART

Patent Literature 1 discloses a manufacturing method of optical fibers with an optical connector ferrule. In the manufacturing method of optical fibers with an optical connector ferrule, a plurality of optical fiber ribbons, from each of which a coating is removed, are inserted into the optical connector ferrule. The optical connector ferrule is provided with a window to be filled with an adhesive. By adjusting a shape and a position of the window, there is shown, in the window, a reference range in which a removal edge of the optical fiber ribbon is to be disposed. An operator can see a position of the removal edge of the optical fiber ribbon from the window. The operator performs insertion operation of the optical fiber ribbon while confirming that the position of the removal edge of the optical fiber ribbon is within the reference range.

### CITATION LIST

### Patent Literature

Patent Literature 1: Japanese Unexamined Patent Publication No. 2011-107633

### SUMMARY OF INVENTION

The optical connector ferrule of this disclosure comprises: a first end and a second end provided to face each other in a first direction; an outer surface extending in the first direction between the first end and the second end; an opening provided in the second end; an introducing hole which extends from the opening toward the first end, and into which a plurality of optical fibers can be inserted as a bundle; a plurality of optical fiber holes which pass through from a tip portion of the introducing hole closer to the first end in the first direction to the first end, and into which the plurality of optical fibers are respectively inserted; and a window which opens to the outer surface and is connected to the introducing hole, and into which an adhesive is injected. A first opening of the window closer to the outer surface is larger than a second opening of the window closer to the introducing hole. An inner wall of the window includes a first surface provided in the peripheral direction of the inner wall, and the first surface is positioned closer to the introducing hole with respect to the outer surface in a second direction orthogonal to the outer surface, and faces toward the outer surface.

An optical connector of this disclosure comprises the above-described optical connector ferrule and the plurality of optical fibers inserted from the opening into the introducing hole and the plurality of optical fiber holes and fixed to the introducing hole and the plurality of optical fiber holes by the adhesive injected from the window.

### BRIEF DESCRIPTION OF DRAWINGS

FIG. 1 is a top view of an optical connector ferrule according to an embodiment.

FIG. 2 is a cross-sectional view of the optical connector ferrule shown in FIG. 1 along the II-II line.

FIG. 3A is a top view enlarging and showing a window of the optical connector ferrule shown in FIG. 1.

FIG. 3B is a cross-sectional view of the window of the optical connector ferrule shown in FIG. 3A along the line.

FIG. 4 is a side cross-sectional view showing a configuration of an optical connector according to an embodiment.

FIG. 5A is a top view enlarging and showing a window of the optical connector ferrule according to an embodiment when an adhesive is injected into the ferrule.

FIG. 5B is a cross-sectional view of the window of the ferrule shown in FIG. 5A along the V-V line.

FIG. 6A is a top view enlarging and showing a window of an optical connector ferrule according to a first modified example.

FIG. 6B is a cross-sectional view of the window of the optical connector ferrule shown in FIG. 6A along the VI-VI line.

FIG. 7A is a top view enlarging and showing a window of an optical connector ferrule according to a second modified example.

FIG. 7B is a cross-sectional view of the window of the optical connector ferrule shown in FIG. 7A along the VII-VII line.

FIG. 8A is a top view enlarging and showing a window of an optical connector ferrule according to a third modified example.

FIG. 8B is a cross-sectional view of the window of the optical connector ferrule shown in FIG. 8A along the VIII-VIII line.

FIG. 9A is a top view enlarging and showing a window of an optical connector ferrule according to a fourth modified example.

FIG. 9B is a cross-sectional view of the window of the optical connector ferrule shown in FIG. 9A along the IX-IX line.

FIG. 10A shows an example of a shape of a window of an optical connector ferrule according to an embodiment.

FIG. 10B shows an example of a shape of a window of an optical connector ferrule according to an embodiment.

FIG. 10C shows an example of a shape of a window of an optical connector ferrule according to an embodiment.

FIG. 10D shows an example of a shape of a window of an optical connector ferrule according to an embodiment.

FIG. 11A is a top view enlarging and showing a window of a conventional optical connector ferrule when an adhesive is injected into the optical connector ferrule.

FIG. 11B is a cross-sectional view of the window of the optical connector ferrule shown in FIG. 11A along the XI-XI line.

### DESCRIPTION OF EMBODIMENTS

### Technical Problem Solved by Disclosure

When an optical connector comprising a configuration containing a plurality of optical fibers in an optical connector ferrule is manufactured, it is necessary that the plurality of optical fibers are fixed to the optical connector ferrule after the plurality of optical fibers are inserted into the optical connector ferrule. Therefore, a window for injecting an adhesive into the optical connector ferrule (ferrule window) is opened on an outer surface of the optical connector ferrule. For example, by injecting the adhesive from the window into the optical connector ferrule by a syringe, the plurality of optical fibers are fixed to the optical connector ferrule. At this time, when the adhesive has spilled out of the window onto the outer surface of the optical connector ferrule, it becomes necessary to perform a process of removing the spilled adhesive from the outer surface. When the spilled adhesive remains on the outer surface of the optical connector ferrule, there is a possibility that, when the optical connector ferrule is held to be floating in a housing, the floating function is impaired by interference from the adhesive to the housing. In this case, there is a possibility that connection performance of the optical connector comprising the optical connector ferrule is deteriorated. Further, since the outer surface of the optical connector ferrule does not meet a reference surface of a polishing table with high accuracy, it becomes difficult to polish a connecting end face of the optical connector ferrule with high accuracy. Consequently, it is desirable that an amount of adhesive to be injected into the optical connector ferrule is adjusted (controlled) so that the adhesive does not spill out of the window onto the outer surface of the optical connector ferrule.

However, since the size of the window is extremely small and the adhesive to be injected into the optical connector ferrule is in minute quantity, it is extremely difficult to adjust the amount of adhesive. Moreover, if the size of the window is enlarged, there is a possibility that, after a molding process of the optical connector ferrule, warpage occurs in the optical connector ferrule. This is because, since an opening portion, such as a window, cannot be provided on a surface facing the outer surface of the optical connector ferrule, thermal shrinkage greatly differs between the surface and the outer surface. The manufacturing method of optical fibers with an optical connector ferrule described in Patent Literature 1 adjusts the shape and the position of the window for injecting the adhesive to dispose the optical fiber ribbons at proper positions; therefore, the method does not solve the problem as described above.

An object of this disclosure is to provide an optical connector ferrule and an optical connector capable of preventing an adhesive from reaching an outer surface from a window for injecting the adhesive.

### Advantageous Effects of Disclosure

According to an optical connector ferrule and an optical connector according to this disclosure, it is possible to prevent an adhesive from reaching an outer surface from a window for injecting the adhesive.

### DESCRIPTION OF EMBODIMENTS OF INVENTION

First, details of an embodiment according to the present invention will be listed and described. An optical connector ferrule according to an embodiment of the present invention comprises: a first end and a second end provided to face each other in a first direction; an outer surface extending in the first direction between the first end and the second end; an opening provided in the second end; an introducing hole which extend from the opening toward the first end, and into which a plurality of optical fibers can be inserted as a bundle; a plurality of optical fiber holes which pass through from a tip portion of the introducing hole closer to the first end in the first direction to the first end, and into which the plurality of optical fibers are respectively inserted; and a window which opens to the outer surface and is connected to the introducing hole, and into which an adhesive is injected, wherein a first opening of the window closer to the outer surface is larger than a second opening of the window closer to the introducing hole, and an inner wall of the window includes a first surface provided in the peripheral direction of the inner wall, and the first surface is positioned closer to the introducing hole with respect to the outer surface in a second direction orthogonal to the outer surface, and faces toward the outer surface.

When an optical connector is manufactured by use of the above-described optical connector ferrule, after the plurality of optical fibers are inserted from the opening into the introducing hole and the plurality of optical fiber holes, the adhesive is injected from the window. By the adhesive, the plurality of optical fibers are fixed to the introducing hole and the plurality of optical fiber holes. Here, since the first opening is larger than the second opening and the first surface facing toward the outer surface is positioned closer to the introducing hole with respect to the outer surface, space for containing the adhesive having reached the first surface is reserved on the first surface. Consequently, it is possible to prevent the adhesive spilled from the introducing hole from reaching the outer surface. Accordingly, the time needed for the process of removing the adhesive from the outer surface can be reduced. Moreover, by adjusting the amount of adhesive using the position of the first surface (for example, the position of one side, of the sides constituting the first surface, closer to the introducing hole than the other sides) as a guide, the amount of adhesive can be suppressed. Consequently, since a stress due to volume changes (contraction stress) of the adhesive when being cured can be kept small, it is possible to keep deformation of the optical connector ferrule small.

In the above-described optical connector ferrule, the inner wall of the window may further include a second surface that connects the outer surface and the first surface, and an angle formed by the outer surface and the first surface may be smaller than an angle formed by the outer surface and the second surface. By providing the second surface like this between the outer surface and the first surface, the adhesive having reached the first surface becomes less likely to reach the outer surface. Consequently, it is possible to further prevent the adhesive from reaching the outer surface.

In the above-described optical connector ferrule, the first surface may be in parallel with the outer surface, or the first surface may be inclined with respect to the outer surface. Consequently, it is possible to suitably realize the above-described window of the optical connector ferrule. Moreover, when the first surface is inclined with respect to the outer surface, an inclination angle of the first surface with respect to the outer surface may be in a range of more than 0 degrees and equal to or less than 45 degrees. The smaller the angle is set, the larger a contact angle between the first surface and the surface of the adhesive becomes. Consequently, wettability between the first surface and the adhesive is reduced, and a surface tension of the adhesive is increased. This causes the adhesive having reached the first surface to be less likely to reach the outer surface; therefore, it is possible to further prevent the adhesive from reaching the outer surface.

In the above-described optical connector ferrule, a total area of the first surface may be equal to or more than 20% of a total area of the first opening, or, the total area of the first surface may be equal to or more than 50% of the total area of the first opening. By providing the first surface having such a total area, the adhesive having reached the first surface is sufficiently contained, and therefore, the adhesive becomes less likely to reach the outer surface. Consequently, it is possible to further prevent the adhesive from reaching the outer surface.

In the above-described optical connector ferrule, the first surface further includes a third surface and a fourth surface, and the third surface may be positioned closer to the center of the window with respect to the fourth surface and may be positioned closer to the introducing hole in the second direction with respect to the fourth surface. Consequently, even when the adhesive has spilled out of the third surface, it is possible to keep the spilled adhesive on the fourth surface. Consequently, it is possible to further prevent the adhesive from reaching the outer surface.

In the above-described optical connector ferrule, the first surface further includes a third surface and a fourth surface, and the third surface may be positioned close to the center of the window with respect to the fourth surface and may be positioned closer to the outer surface in the second direction with respect to the fourth surface. Consequently, even when the adhesive spills out of the third surface, it is possible to keep the spilled adhesive on the fourth surface. Consequently, it is possible to further prevent the adhesive from reaching the outer surface.

The above-described optical connector ferrule further comprises a step provided to the outer surface, and the step may protrude outwardly in the second direction from the outer surface closer to the first end with respect to the step. Moreover, in this case, the window may be separated from the step toward a front end in the first direction, and the first surface may be provided to, except for one portion, the other portions in the peripheral direction of the inner wall of the window, and the one portion may be closer to the step than the other portions. When the adhesive has reached the outer surface, there is a possibility that the adhesive adheres not only to the outer surface but also to the step. Further, it is difficult to remove the adhesive adhered to a corner portion formed by the step and the outer surface. Accordingly, there is a possibility that the time needed for the process of removing the adhesive is increased. Therefore, by providing the first surface at the other portions, except for one portion at the position closer to the step, in the inner wall of the window, the adhesive having reached the first surface can be separated from the step. This causes the adhesive to rarely reach the step, to thereby make it possible to prevent the time needed for the process of removing the adhesive from increasing.

In the above-described optical connector ferrule, the window may have a rectangular shape, a polygonal shape, a circular shape, an elliptical shape or a partially rounded shape.

An optical connector according to an embodiment of the present invention may comprise any one of the above-described optical connector ferrules and the plurality of optical fibers inserted from the opening into the introducing hole and the plurality of optical fiber holes and fixed to the introducing hole and the plurality of optical fiber holes by the adhesive injected from the window. As described above, according to the above-described optical connector ferrule, it is possible to keep deformation by the contraction stress of the adhesive small; therefore, according to the above-described optical connector comprising the above-described optical connector ferrule, it is possible to obtain good optical properties. Moreover, in this case, the adhesive may remain inside the window, not on the outer surface, in the second direction.

### DETAILS OF EMBODIMENTS OF INVENTION

Hereinafter, specific examples of an optical connector ferrule and an optical connector according to an embodiment of the present invention will be described with reference to drawings. It is intended that the present invention is not limited to these examples, but defined by the claims, and all changes equivalent to meaning of the claims and within the scope of the claims are included in the present invention. In the following description, in description of the drawings, common components are assigned with the same reference sign, and redundant description is omitted.

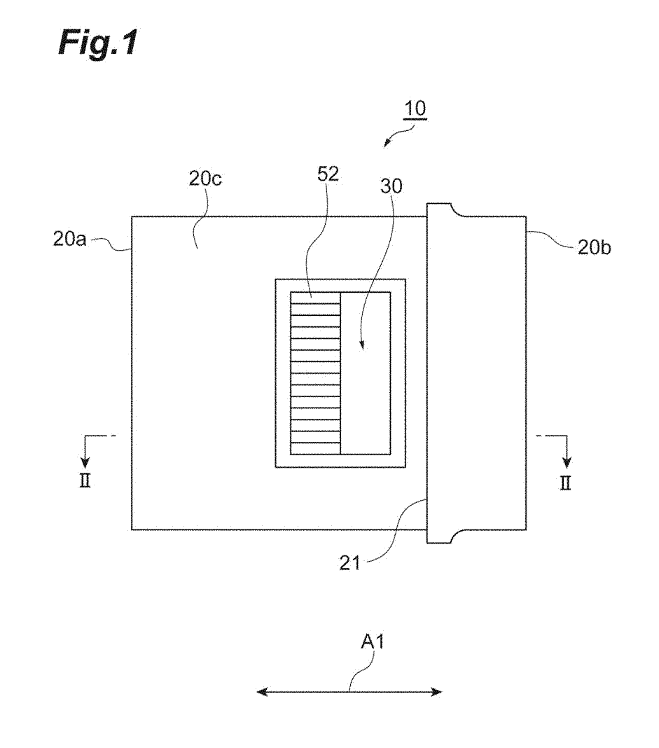

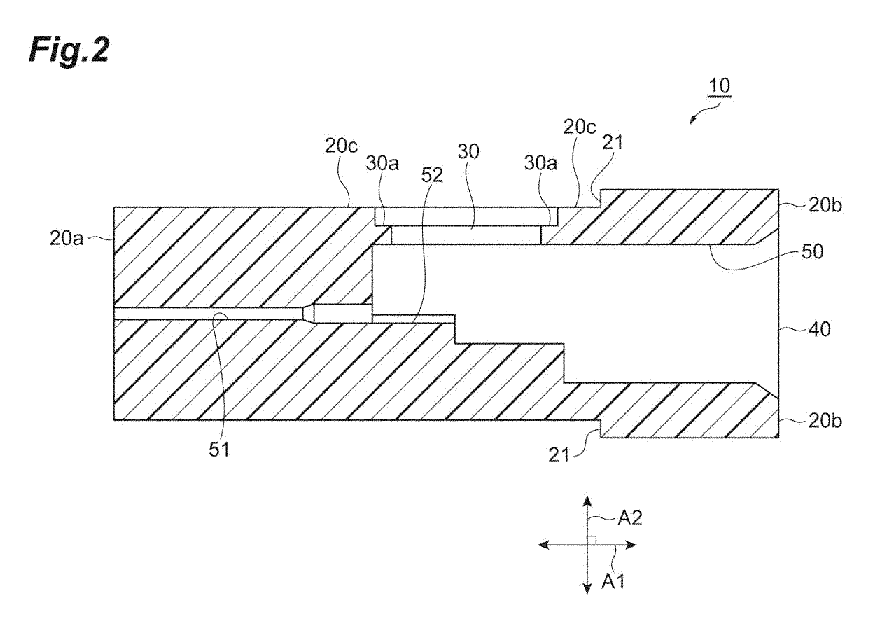

FIG. 1 is a top view of an optical connector ferrule 10 according to the embodiment. FIG. 2 is a cross-sectional view of the optical connector ferrule 10 shown in FIG. 1 along the II-II line. The optical connector ferrule 10 according to the embodiment (hereinafter, simply referred to as “ferrule 10”) is, for example, an MT optical connector ferrule. The ferrule 10 has an outer appearance substantially in a shape of rectangular parallelepiped with a first direction A1 as the longitudinal direction. As shown in FIGS. 1 and 2, the ferrule 10 comprises a front end surface 20a (a first end), a rear end surface 20b (a second end), a top surface 20c (an outer surface), a step 21, an opening 40, an introducing hole 50, a plurality of optical fiber holes 51, and a window 30. The front end surface 20a and the rear end surface 20b are provided to face each other in the first direction A1. The top surface 20c connects the front end surface 20a and the rear end surface 20b via the step 21. The top surface 20c is formed in the first direction A1. The step 21 is formed at a rear end of the top surface 20c closer to the rear end surface 20b in the first direction A1. The step 21 protrudes outwardly in a second direction A2 orthogonal to the top surface 20c (in an example, the second direction A2 is also orthogonal to the first direction A1) from the top surface 20c closer to the front end surface 20a with respect to the step 21. In an example, the step 21 consists of a flange-shaped portion formed at a rear end portion of the ferrule 10 closer to the rear end surface 20b in the first direction A1.

The opening 40 opens on the rear end surface 20b and receives a plurality of optical fibers. The introducing hole 50 extends from the opening 40 toward the front end surface 20a. The plurality of optical fibers are inserted into the introducing hole 50 as a bundle. Fiber grooves 52 are provided at the tip portion of the introducing hole 50 closer to the front end surface 20a in the first direction A1. The fiber grooves 52 are provided at positions that can be visually recognized from the window 30. A plurality of optical fiber holes 51 extend in the first direction A1 to penetrate from the tip portion of the introducing hole 50 to the front end surface 20a. The plurality of optical fiber holes 51 are arranged one-dimensionally or two-dimensionally on a cross section perpendicular to the first direction A1. The plurality of optical fibers guided by the fiber grooves 52 is respectively inserted into the plurality of optical fiber holes 51.

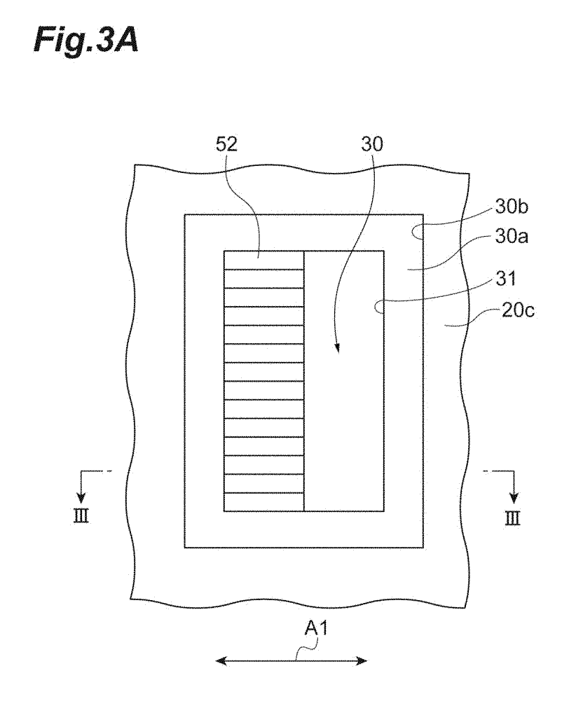

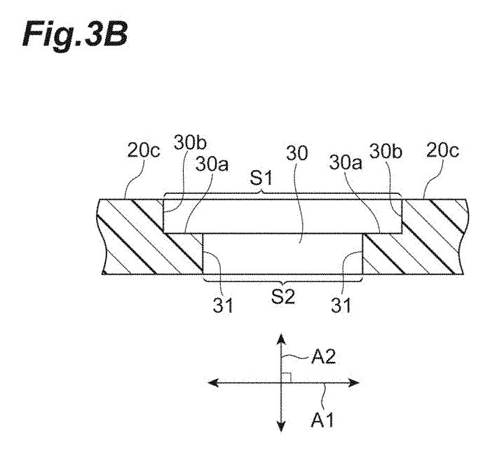

The window 30 opens on the top surface 20c and is connected to the introducing hole 50. The window 30 is provided to a position separated from the step 21 toward the front end surface 20a in the first direction A1. The window 30 is provided to inject the adhesive into the introducing hole 50 and the plurality of optical fiber holes 51. In an example, the window 30 has a rectangular shape with the first direction A1 as the short direction, and includes four sides constituting an inner wall of the window 30. Of these four sides, two sides in the longitudinal direction extend in a direction orthogonal to the first direction A1 and the second direction A2. Of the two sides in the longitudinal direction, one side is provided at a position closer to the step 21 than the other three sides. Of the four sides, two sides in the short direction are perpendicular to the two sides in the longitudinal direction. FIG. 3A is a top view enlarging and showing the window 30 of the ferrule 10 shown in FIG. 1. FIG. 3B is a cross-sectional view of the window 30 shown in FIG. 3A along the line. As shown in FIG. 3B, in the second direction A2, a first opening S1 of the window 30 closer to the top surface 20c is larger than a second opening S2 of the window 30 closer to the introducing hole 50. Here, the first opening S1 being larger than the second opening S2 means that, for example, an area of the first opening S1 is larger than an area of the second opening S2. The inner wall of the window 30 includes a first surface 30a, a second surface 30b and a surface 31. The first surface 30a, the second surface 30b and the surface 31 are provided at least at one portion of the inner wall of the window 30 in the peripheral direction. In this embodiment, the first surface 30a, the second surface 30b and the surface 31 are provided over whole circumference of the inner wall of the window 30. In an example, a ratio of the area of the first surface 30a to the area of the first opening S1 is equal to or more than 20%, and more preferably, equal to or more than 50%. The first surface 30a faces toward the top surface 20c, and is positioned closer to the introducing hole 50 with respect to the top surface 20c in the second direction A2. Here, facing toward the top surface 20c means that a normal vector of the first surface 30a contains a component of the second direction A2 and the component faces toward the top surface 20c. In an example, the first surface 30a is positioned equal to or more than 0.1 mm, and more preferably, equal to or more than 0.3 mm away from the top surface 20c toward the introducing hole 50. Moreover, an angle formed by the top surface 20c and the first surface 30a is smaller than an angle formed by the top surface 20c and the second surface 30b. In an example, the first surface 30a is in parallel with the top surface 20c and the second surface 30b is perpendicular to the top surface 20c. The surface 31 connects the first surface 30a and the introducing hole 50, and in an example, the surface 31 is perpendicular to the top surface 20c.

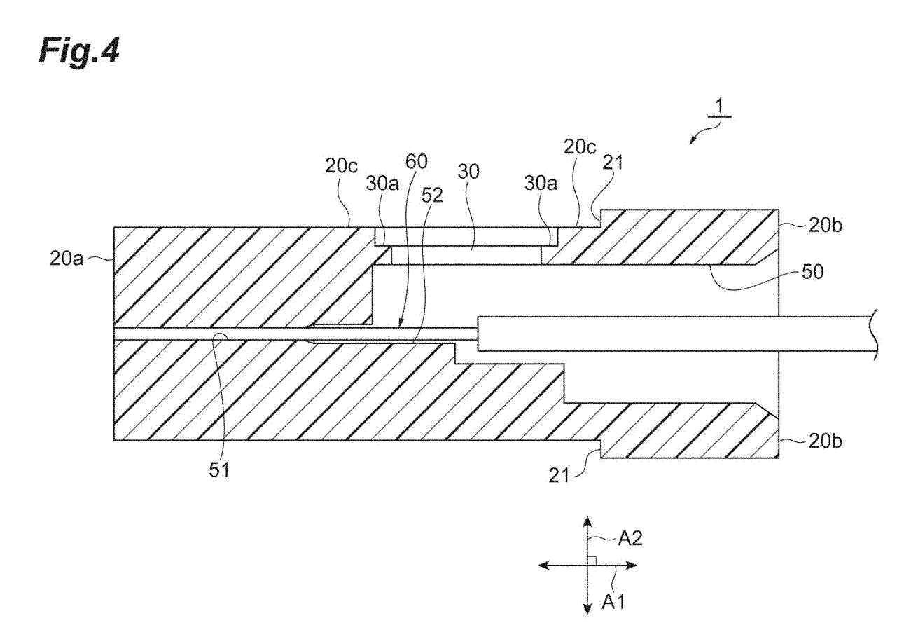

An optical connector 1 of the embodiment is configured with the ferrule 10 and a plurality of optical fibers. FIG. 4 is a side cross-sectional view showing a configuration of the optical connector 1 according to the embodiment. With reference to FIG. 4, a plurality of optical fibers 60 are inserted from the opening 40 into the introducing hole 50, and, while being guided by the fiber grooves 52, respectively inserted into the plurality of optical fiber holes 51. At this time, an operator can visually recognize the plurality of optical fibers 60 from the window 30. When the adhesive is injected from the window 30 in this state, the plurality of optical fibers 60 are fixed to the introducing hole 50 and the plurality of optical fiber holes 51 by the adhesive together.

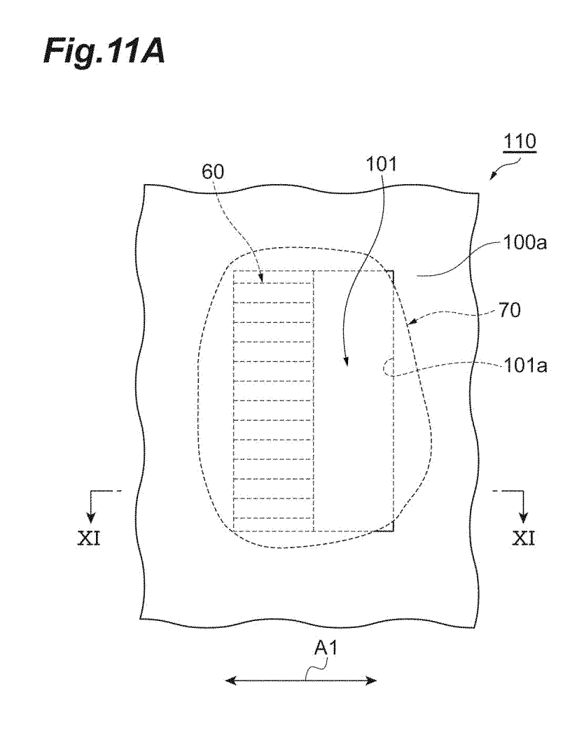

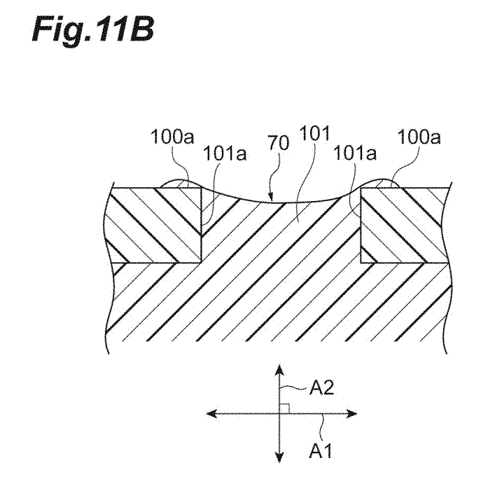

Description will be given of effects obtained by the ferrule 10 and optical connector 1 according to the embodiment as described above. As described above, when the adhesive is injected from the window 30 of the ferrule 10, the plurality of optical fibers 60 are fixed to the introducing hole 50 and the plurality of optical fiber holes 51. At this time, it is desirable that the adhesive injected into the ferrule 10 does not spill out of the window 30 onto the top surface 20c. However, in a window of a conventional ferrule (for example, refer to Patent Literature 1), there is a problem that an adhesive is likely to reach a top surface of the ferrule from the window. FIG. 11A is a top view enlarging and showing a window 101 of such a ferrule 110 when an adhesive 70 is injected into an optical connector comprising the ferrule 110. FIG. 11B is a cross-sectional view of the window 101 shown in FIG. 11A along the XI-XI line. With reference to FIGS. 11A and 11B, an inner wall 101a of the window 101 is perpendicular to a top surface 100a. When the adhesive 70 is injected from the window 101 in this state, as shown in FIGS. 11A and 11B, the adhesive 70 is likely to reach the top surface 100a.

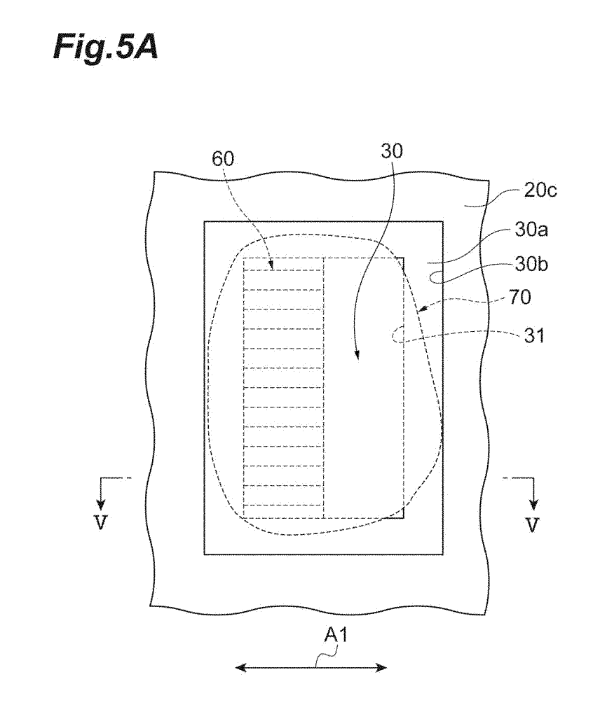

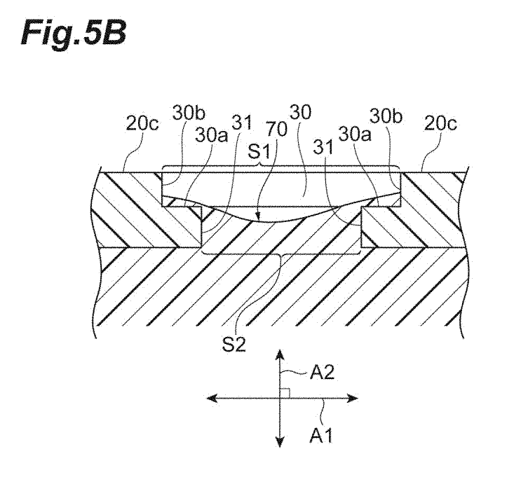

FIG. 5A is a top view enlarging and showing an example of the window 30 of the ferrule 10 when the adhesive 70 is injected into the optical connector 1 of the embodiment. FIG. 5B is a cross-sectional view of the window 30 shown in FIG. 5A along the V-V line. As shown in FIGS. 5A and 5B, in the embodiment, the first opening S1 is larger than the second opening S2, and the first surface 30a facing toward the top surface 20c is positioned closer to the introducing hole 50. Consequently, space for containing the adhesive 70 having reached the first surface 30a is reserved on the first surface 30a. Therefore, since the adhesive 70 spilled from the introducing hole 50 remains in the space on the first surface 30a, it is possible to prevent the adhesive 70 from reaching the top surface 20c. Accordingly, it is possible to reduce the time needed for the process of removing the adhesive 70 from the top surface 20c. Moreover, the amount of adhesive 70 can be suppressed by adjusting the amount of adhesive 70 using the position of the first surface 30a in the second direction A2 as a guide. Consequently, since this can keep a contraction stress of adhesive 70 when being cured small, it is possible to keep deformation of the ferrule 10 small.

As in the embodiment, the inner wall of the window 30 includes the second surface 30b that connects the top surface 20c and the first surface 30a, and the angle formed by the top surface 20c and the first surface 30a may be smaller than the angle formed by the top surface 20c and the second surface 30b. The adhesive 70 having reached the first surface 30a becomes less likely to reach the top surface 20c by providing the second surface 30b between the top surface 20c and the first surface 30a, as shown in FIGS. 3A and 3B. This can further prevent the adhesive 70 from reaching the top surface 20c.

The optical connector 1 according to the embodiment may comprise, as shown in FIG. 4, the ferrule 10 and the plurality of optical fibers 60 inserted from the opening 40 into the introducing hole 50 and the plurality of optical fiber holes 51 along the first direction A1 and fixed to the introducing hole 50 and the plurality of optical fiber holes 51 by the adhesive 70 injected from the window 30. As described above, it is possible to keep deformation due to the contraction stress of the adhesive 70 small by the ferrule 10; therefore, the optical connector 1 comprising the ferrule 10 can obtain good optical properties.

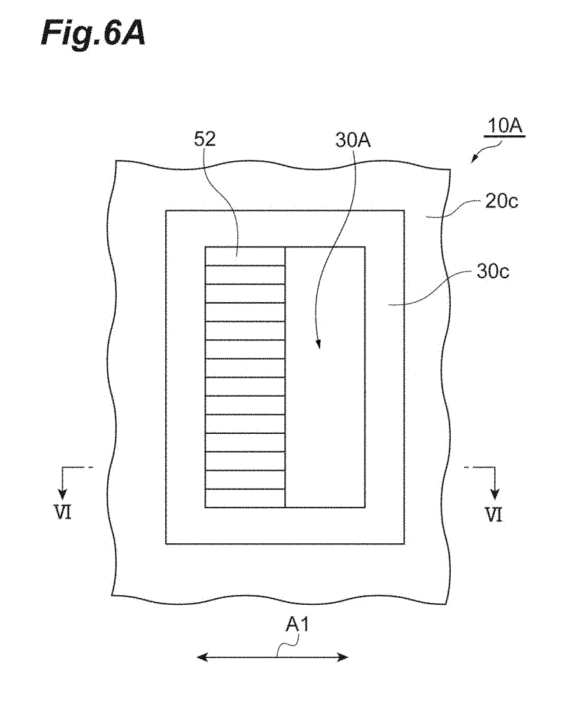

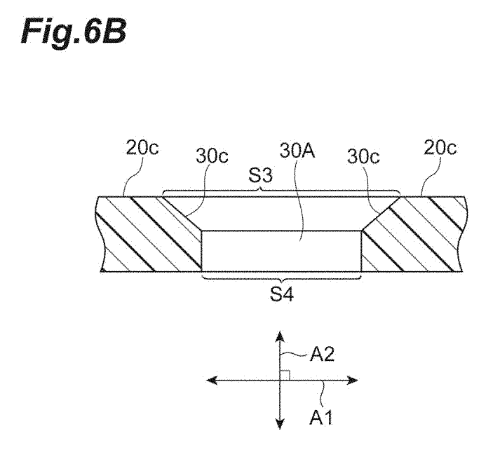

(First modified example) FIG. 6A is a top view enlarging and showing a window 30A of a ferrule 10A according to a first modified example of the above-described embodiment. FIG. 6B is a cross-sectional view of the window 30A of the ferrule 10A shown in FIG. 6A along the VI-VI line. A difference between the modified example and the above-described embodiment is inclination of the first surface. That is, the first surface 30c of the window 30A in the ferrule 10A of the modified example is, as shown in FIG. 6B, inclined with respect to the top surface 20c. In other words, the normal vector of the first surface 30c is inclined toward inside of the window 30. Even when the first surface 30c is inclined in this manner, it is possible to suitably realize the configuration in which a first opening S3 of the window 30A closer to the top surface 20c is larger than a second opening S4 of the window 30A closer to the introducing hole 50 and the first surface 30c facing toward the top surface 20c is positioned closer to the introducing hole 50. Further, the inclination angle of the first surface 30c with respect to the top surface 20c may be set within a range that is more than 0 degrees and equal to or less than 45 degrees. The smaller the inclination angle is set, the larger a contact angle between the first surface 30c and the surface of the adhesive 70 becomes. Consequently, wettability between the first surface 30c and the adhesive 70 is reduced, and a surface tension of the adhesive 70 is increased. This causes the adhesive 70 having reached the first surface 30c to be less likely to reach the top surface 20c; therefore, it is possible to further prevent the adhesive 70 from reaching the top surface 20c. Moreover, for example, the amount of adhesive 70 can be suppressed by adjusting the amount of adhesive 70 using the position of, of the sides constituting the first surface 30c, one side closer to the introducing hole 50 than the other sides as a guide.

### Second Modified Example

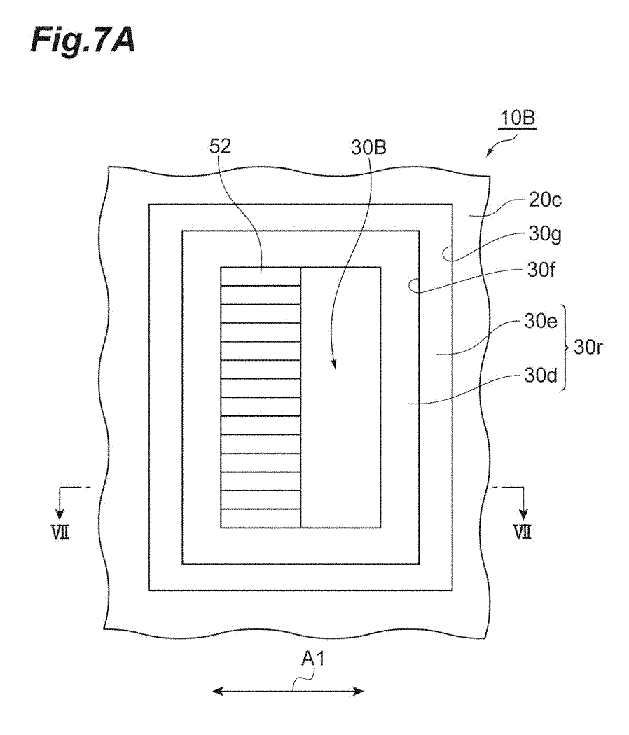

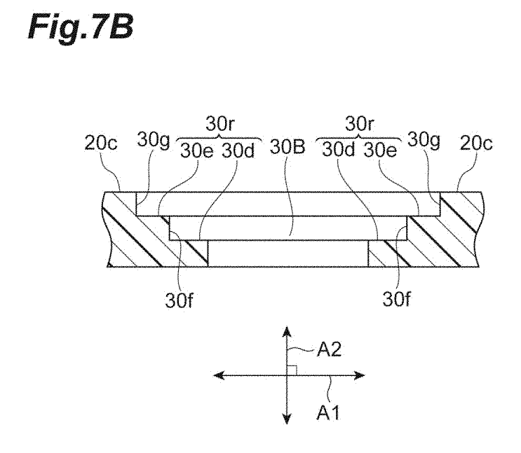

FIG. 7A is a top view enlarging and showing a window 30B of a ferrule 10B according to a second modified example of the above-described embodiment. FIG. 7B is a cross-sectional view of the window 30B of the ferrule 10B shown in FIG. 7A along the VII-VII line. A difference between the modified example and the above-described embodiment is the number of surfaces constituting the first surface. That is, the first surface 30a of the above-described embodiment is configured with one surface; however, a first surface 30r of the inner wall of the window 30B in the modified example is divided into two surfaces (a third surface 30d and a fourth surface 30e). As shown in FIGS. 7A and 7B, the inner wall of the window 30B includes the third surface 30d, the fourth surface 30e, a fifth surface 30f and a sixth surface 30g. The third surface 30d is positioned closer to the center of the window 30B with respect to the fourth surface 30e. Further, the fourth surface 30e is positioned closer to the top surface 20c of the ferrule 10B in the second direction A2 with respect to the third surface 30d. In an example, the third surface 30d and the fourth surface 30e are in parallel with the top surface 20c. The fifth surface 30f connects the third surface 30d and the fourth surface 30e, and the sixth surface 30g connects the fourth surface 30e and the top surface 20c. In an example, the fifth surface 30f and the sixth surface 30g are perpendicular to the top surface 20c. By providing the third surface 30d and the fourth surface 30e in this manner, even when the adhesive 70 has spilled out of the third surface 30d, it is possible to keep the spilled adhesive 70 on the fourth surface 30e. This can further prevent the adhesive 70 from reaching the top surface 20c. At least one of the third surface 30d and the fourth surface 30e may be inclined as the first surface 30c in the first modified example.

### Third Modified Example

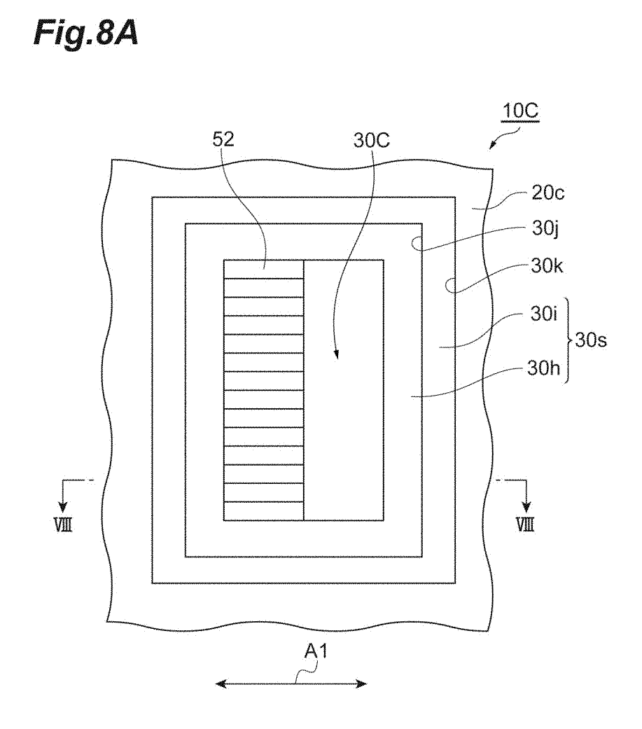

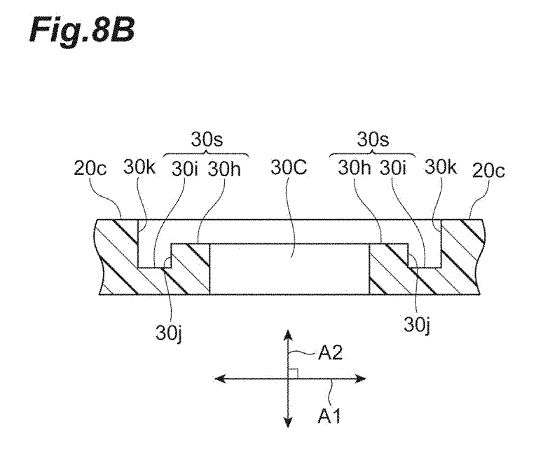

FIG. 8A is a top view enlarging and showing a window 30C of a ferrule 10C according to a third modified example of the above-described embodiment. FIG. 8B is a cross-sectional view of the window 30 of the ferrule 10C shown in FIG. 8A along the VIII-VIII line. A difference between the modified example and the above-described embodiment is the number of surfaces constituting the first surface. That is, the first surface 30a of the above-described embodiment is configured with one surface; however, a first surface 30s of the inner wall of the window 30C in the modified example is divided into two surfaces (a third surface 30h and a fourth surface 30i). As shown in FIGS. 8A and 88, the inner wall of the window 30C includes the third surface 30h, the fourth surface 30i, a fifth surface 30j and a sixth surface 30k. The third surface 30h is positioned closer to the center of the window 30C with respect to the fourth surface 30i. Further, the third surface 30h is positioned closer to the top surface 20c of the ferrule 10C in the second direction A2 with respect to the fourth surface 30i. In an example, the third surface 30h and the fourth surface 30i are in parallel with the top surface 20c. The fifth surface 30j connects the third surface 30h and the fourth surface 30i, and the sixth surface 30k connects the fourth surface 30i and the top surface 20c. In an example, the fifth surface 30j and the sixth surface 30k are perpendicular to the top surface 20c. By providing the third surface 30h and the fourth surface 30i, even when the adhesive 70 spills out of the third surface 30h, it is possible to keep the spilled adhesive 70 on the fourth surface 30i. This can further prevent the adhesive 70 from reaching the top surface 20c. Note that at least one of the third surface 30h and the fourth surface 30i may be inclined as the first surface 30c in the first modified example.

### Fourth Modified Example

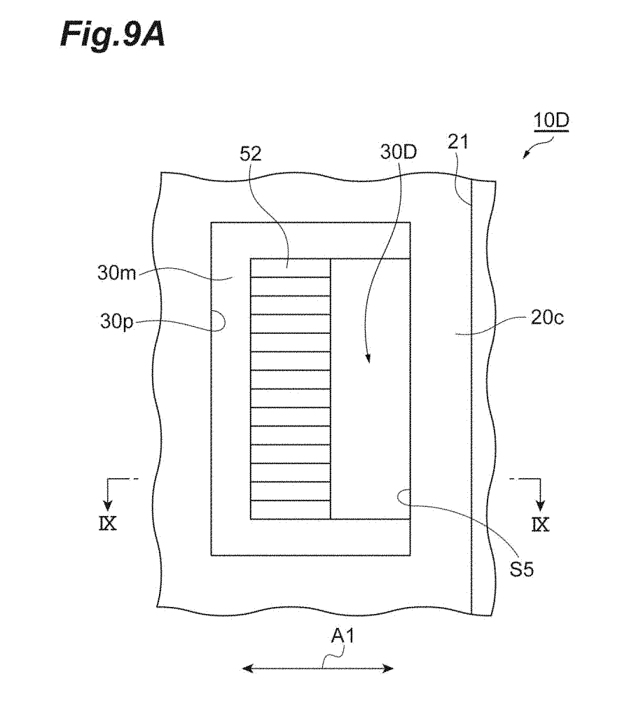

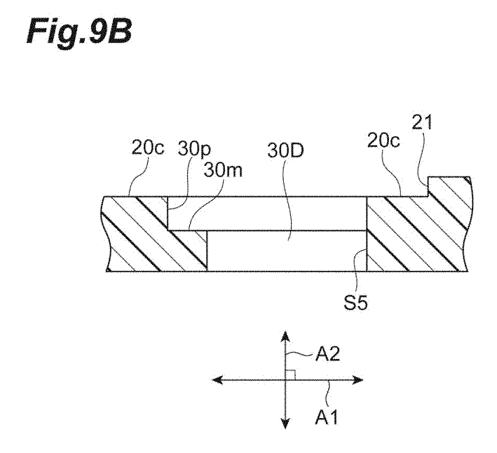

FIG. 9A is a top view enlarging and showing a window 30D of a ferrule 10D according to a fourth modified example of the above-described embodiment. FIG. 9B is a cross-sectional view of the window 30D of the ferrule 10D shown in FIG. 9A along the IX-IX line. A difference between the modified example and the above-described embodiment is arrangement of the first surface. That is, the first surface 30a of the above-described embodiment was provided over whole circumference in the peripheral direction of the inner wall of the window 30; however, a first surface 30m of the modified example is provided to a portion along the peripheral direction of the inner wall of the window 30D except for one portion S5. As shown in FIGS. 9A and 9B, the inner wall of the window 30D includes the first surface 30m and a second surface 30p. The shape of the first surface 30m and the second surface 30p is similar to the first surface 30a and the second surface 30b of the above-described embodiment except for the point of not being provided at the one portion S5 in the inner wall of the window 30D. The one portion S5 in the inner wall of the window 30D is positioned closer to the step 21 than the other portions of the inner wall. Specifically, the one portion S5 corresponds to, of the four sides constituting the window 30D in the rectangular shape, a side closest to the step 21. The other configuration except for the first surface 30m and the second surface 30p is the same as the configuration of the ferrule 10 of the above-described embodiment.

Here, when the adhesive 70 reaches the top surface 20c, if the adhesive 70 reaches the step 21, the adhesive adheres not only to the top surface 20c, but also to the step 21. Further, since the step 21 rises up from the top surface 20c, the step 21 and the top surface 20c form a corner portion; it is difficult to remove the adhesive 70 adhered to such a corner portion. Accordingly, there is a possibility that the time needed for the process of removing the adhesive 70 is increased. Therefore, by providing the first surface 30m at the other portions except for the one portion at the position closer to the step 21 in the inner wall of the window 30D, the adhesive having reached the first surface 30m can be separated from the step 21. This makes it possible for the adhesive 70 to rarely reach the step 21, to thereby make it possible to prevent the time needed for the process of removing the adhesive 70 from increasing.

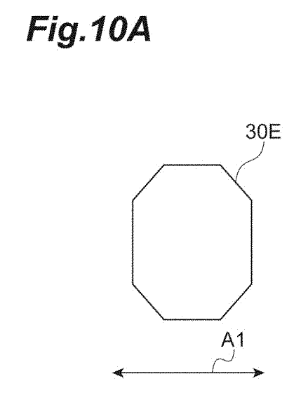

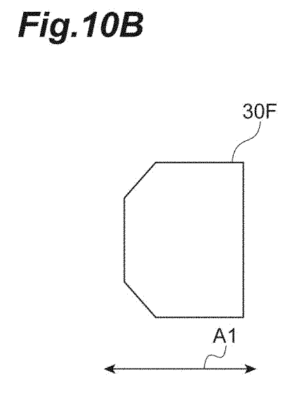

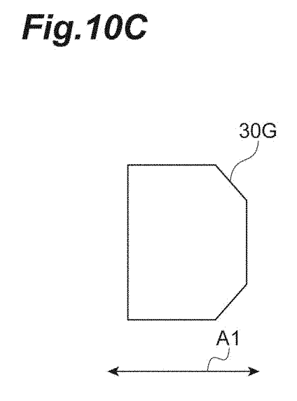

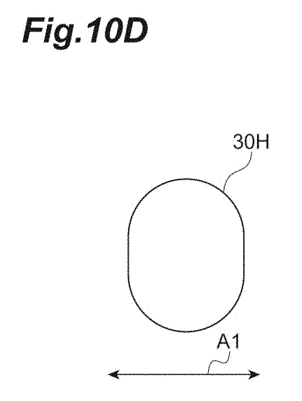

The optical connector ferrule and the optical connector according to the present invention are not limited to the above-described embodiment, and various other modifications are available. For example, the above-described embodiment and each modified example may be combined with one another according to required purposes and effects. Moreover, in the above-described embodiment and each modified example, the shape of the window was rectangle; however, the shape of the window may be other than the rectangle. FIGS. 10A to 10D are top views showing other examples of the shape of the window of the ferrule. The shape of the window may be those shown in FIGS. 10A to 10D. For example, the window may be a window 30E having an octagonal shape (a polygonal shape) obtained by cutting all corners of the rectangular shape as shown in FIG. 10A, a window 30F having a hexagonal shape obtained by cutting corners on one side (the left side in the figure) of the rectangular shape as shown in FIG. 10B, or a window 30G having a hexagonal shape obtained by cutting corners on the other side (the right side in the figure) of the rectangular shape as shown in FIG. 10C. Moreover, as shown in FIG. 10D, by forming a window 30H into a rounded shape, a circular shape or an elliptical shape, the adhesive may be made to hardly spill from the window 30H.

Moreover, in the above-described embodiment, the front end surface and the rear end surface facing each other were parallel; however, these surfaces may not be parallel.

### REFERENCE SIGNS LIST

1 . . . optical connector; 10, 10A to 10D, 110 . . . ferrule; 20a . . . front end surface (first end); 20b . . . rear end surface (second end); 20c . . . top surface (outer surface); 21 . . . step; 30, 30A to 30D, 101 . . . window; 30a, 30c, 30m, 30r, 30s . . . first surface; 30b, 30p . . . second surface; 30d, 30h . . . third surface; 30e, 30i . . . fourth surface; 30f, 30j . . . fifth surface; 30g, 30k . . . sixth surface; 40 . . . opening; 50 . . . introducing hole; 51 . . . optical fiber hole; 52 . . . fiber groove; 60 . . . optical fiber; 70 . . . adhesive; 101a . . . inner wall; A1 . . . first direction; A2 . . . second direction.

1: An optical connector ferrule comprising:
a first end and a second end provided to face each other in a first direction;
an outer surface extending in the first direction between the first end and the second end;
an opening provided in the second end;
an introducing hole extending from the opening toward the first end, into which a plurality of optical fibers can be inserted as a bundle;
a plurality of optical fiber holes passing through from a tip portion of the introducing hole closer to the first end in the first direction to the first end, into which the plurality of optical fibers are respectively inserted; and
a window opened on the outer surface and connected to the introducing hole, into which an adhesive is injected,
wherein a first opening of the window closer to the outer surface is larger than a second opening of the window closer to the introducing hole, and
wherein an inner wall of the window includes a first surface provided in a peripheral direction of the inner wall, and the first surface is positioned closer to the introducing hole with respect to the outer surface in a second direction orthogonal to the outer surface, and faces toward the outer surface.

2: The optical connector ferrule according to claim 1, wherein the inner wall further includes a second surface connecting the outer surface and the first surface, and an angle formed by the outer surface and the first surface is smaller than an angle formed by the outer surface and the second surface.

3: The optical connector ferrule according to claim 1, wherein the first surface is in parallel with the outer surface.

4: The optical connector ferrule according to claim 1, wherein the first surface is inclined with respect to the outer surface.

5: The optical connector ferrule according to claim 4, wherein an inclination angle of the first surface with respect to the outer surface is in a range of more than 0 degree and equal to or less than 45 degrees.

6: The optical connector ferrule according to claim 1, wherein a total area of the first surface is equal to or more than 20% of a total area of the first opening.

7: The optical connector ferrule according to claim 6, wherein the total area of the first surface is equal to or more than 50% of the total area of the first opening.

8: The optical connector ferrule according to claim 1,
wherein the first surface includes a third surface and a fourth surface, and
wherein the third surface is positioned closer to the center of the window with respect to the fourth surface and is positioned closer to the introducing hole in the second direction with respect to the fourth surface.

9: The optical connector ferrule according to claim 1,
wherein the first surface includes a third surface and a fourth surface, and
wherein the third surface is positioned closer to the center of the window with respect to the fourth surface and is positioned closer to the outer surface in the second direction with respect to the fourth surface.

10: The optical connector ferrule according to claim 1, further comprising:
a step provided to the outer surface, the step protruding outwardly in the second direction from the outer surface closer to the first end with respect to the step.

11: The optical connector ferrule according to claim 10,
wherein the window is separated from the step toward the first end in the first direction, and
wherein the first surface is provided to, except for one portion, the other portions in the peripheral direction of the inner wall, the one portion being closer to the step than the other portions.

12: The optical connector ferrule according to claim 1, wherein the window has a rectangular shape, a polygonal shape, a circular shape, an elliptical shape or a partially rounded shape.

13: An optical connector comprising:
the optical connector ferrule according to claim 1; and
the plurality of optical fibers inserted from the opening into the introducing hole and the plurality of optical fiber holes and fixed to the introducing hole and the plurality of optical fiber holes by the adhesive injected from the window.

14: The optical connector according to claim 13, wherein the adhesive remains inside the window, not on the outer surface, in the second direction.
